(19) United States
(12) Patent Application Publication
(10) Pub. No.: US 2017/0078547 A1
(43) Pub. Date: Mar. 16, 2017

(54) WEARABLE IMAGE PICKUP APPARATUS

(71) Applicant: Kabushiki Kaisha Toshiba, Tokyo (JP)

(72) Inventor: Mitsuhiro Murakami, Ome Tokyo (JP)

(21) Appl. No.: 15/052,361

(22) Filed: Feb. 24, 2016

(30) Foreign Application Priority Data
Sep. 10, 2015 (JP) 2015-178501

(51) Int. Cl. H04N 5/225

(52) U.S. Cl. CPC H04N 5/2259; H04N 5/2253

(57) ABSTRACT

According to one embodiment, a wearable image pickup apparatus includes a mounting unit mounted on a user, and an image pickup unit arranged on the mounting unit. The image pickup unit includes a fixed portion fixed to the mounting unit, and a movable portion movably coupled to the fixed portion by a coupling mechanism. The movable portion includes a camera module configured to image a subject, and a laser beam irradiation module configured to irradiate a laser beam. The camera module and the laser beam irradiation module are arranged to irradiate the laser beam from the laser beam irradiation module within the range of an angle of view of the camera module.

### CROSS-REFERENCE TO RELATED APPLICATIONS

This application is based upon and claims the benefit of priority from Japanese Patent Application No. 2015-178501, filed Sep. 10, 2015, the entire contents of which are incorporated herein by reference.

### FIELD

Embodiments described herein relate generally to a wearable image pickup apparatus.

### BACKGROUND

A wearable image pickup apparatus which is carried by being worn on a part of the user's body, and is capable of capturing a desired image is known. For example, a spectacle-type image pickup apparatus which can be mounted on the user's head has been put to practical use. According to a spectacle-type image pickup apparatus, it becomes possible to easily capture an image corresponding to the user's field of view in real time.

In order to capture an image corresponding to the user's field of view, an image must be captured while an angle of view of the image pickup apparatus is brought into agreement with the user's field of view. For correction of such an angle of view, various kinds of automation technology have been proposed from the past.

However, since the field of view differs greatly according to each person, correcting the angle of view automatically to an optimum state in accordance with the field of view of each user who uses the spectacle-type image pickup apparatus has limitations. Accordingly, the view of the user and the angle of view of the image pick up apparatus may not match with the automatic correction. In particular, in a case where a single image pickup apparatus is used by several people in turn, correction may not be performed optimally, and an image is likely to be captured in a state in which the angle of view is out of the field of view.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing a wearable image pickup apparatus according to an embodiment.

FIG. 2 is an exemplary plan view showing the wearable image pickup apparatus according to the embodiment.

FIG. 3 is an exemplary plan view showing a movable portion of the wearable image pickup apparatus according to the embodiment.

FIG. 4 is an exemplary illustration showing the movable portion of the wearable image pickup apparatus according to the embodiment from the direction of arrow A31 in FIG. 3.

FIG. 5 is an exemplary illustration showing the movable portion of the wearable image pickup apparatus according to the embodiment from the direction of arrow A32 in FIG. 3.

FIG. 6 is an exemplary plan view showing the state of the movable portion of the wearable image pickup apparatus according to the embodiment before it is moved.

FIG. 7 is an exemplary plan view showing the state of the movable portion of the wearable image pickup apparatus according to the embodiment after it has been moved.

FIG. 8 is an exemplary side view showing the state of the movable portion of the wearable image pickup apparatus according to the embodiment before it is moved.

FIG. 9 is an exemplary side view showing the state of the movable portion of the wearable image pickup apparatus according to the embodiment after it has been moved.

FIG. 10 is an exemplary perspective view showing an example of an aspect of a coupling mechanism of the wearable image pickup apparatus according to the embodiment.

FIG. 11 is an exemplary perspective view showing another example of an aspect of a coupling mechanism of the wearable image pickup apparatus according to the embodiment.

### DETAILED DESCRIPTION

Various embodiments will be described hereinafter with reference to the accompanying drawings. In general, according to one embodiment, a wearable image pickup apparatus comprises a mounting unit mounted on a user, and an image pickup unit arranged on the mounting unit. The image pickup unit comprises a fixed portion fixed to the mounting unit, and a movable portion movably coupled to the fixed portion by a coupling mechanism. The movable portion comprises a camera module configured to image a subject, and a laser beam irradiation module configured to irradiate a laser beam. The camera module and the laser beam irradiation module are arranged to irradiate the laser beam from the laser beam irradiation module within the range of an angle of view of the camera module.

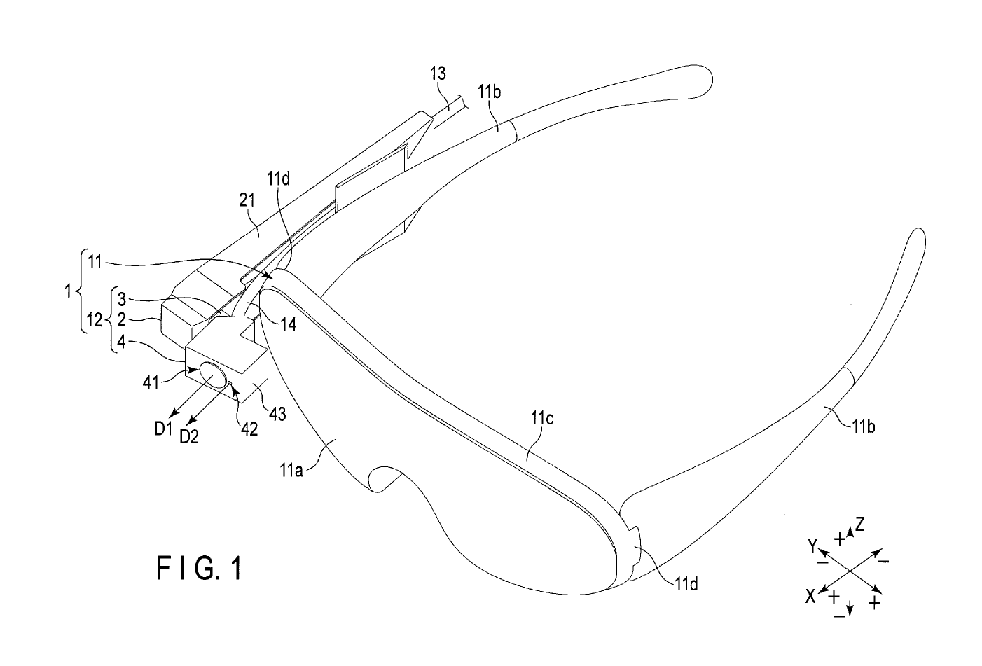

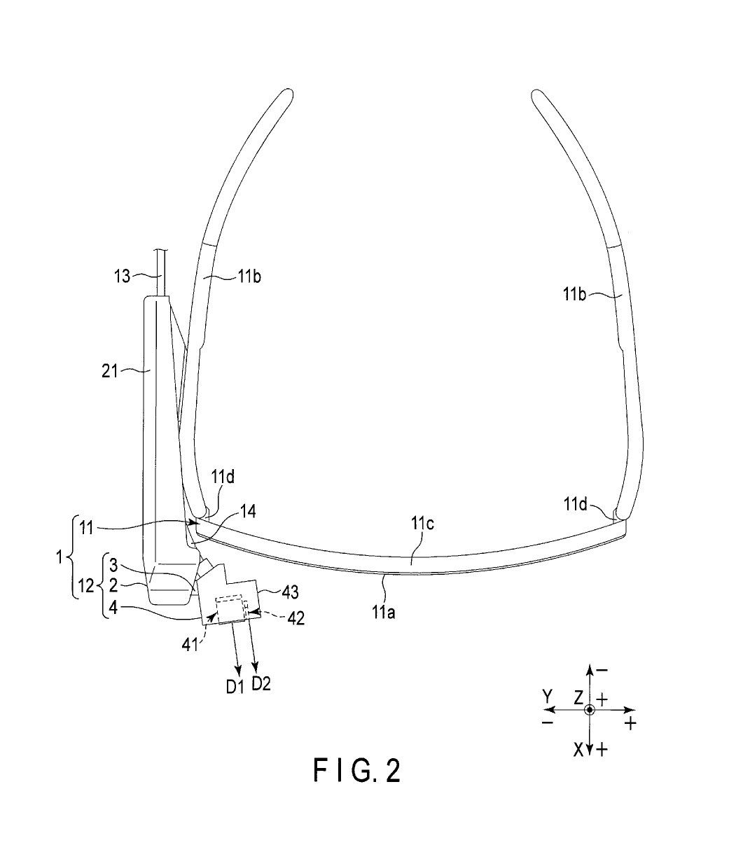

Hereinafter, a wearable image pickup apparatus according to an embodiment (also called an image pickup apparatus as appropriate) will be described with reference to FIGS. 1 to 11 based on an example of camera-equipped glasses. For convenience of explanation, each of “front”, “back”, “right”, “left”, “up”, and “down” is defined from the side of the user with the image pickup apparatus being worn. Accordingly, the direction indicated by “+” of arrow X shown in FIGS. 1 and 2 corresponds to the front side, the direction indicated by “+” of arrow Y corresponds to the left side, and the direction indicated by “+” of arrow Z corresponds to the upper side. Also, the direction of approaching the user's face is defined as the inner (interior) side and the direction of moving away from the face as the outer (exterior) side. Similarly, the directions are defined in accordance with the directions indicated by arrows X, Y, and Z, respectively, in all the other drawings besides FIGS. 1 and 2.

FIG. 1 is a perspective view of a wearable image pickup apparatus 1 of the embodiment as seen from the front upper left side. FIG. 2 is a plan view of the wearable image pickup apparatus 1 of the embodiment as seen from the upper side. As shown in FIGS. 1 and 2, the wearable image pickup apparatus 1 of the embodiment comprises a mounting unit 11 which is worn on the user's head, and an image pickup unit 12 which is arranged on the mounting unit 11. The mounting unit 11 is shaped like glasses including a glass lens portion 11a and a temple portion 11b. In this embodiment, while the mounting unit 11 is described as safety glasses (goggles) for work, it may take the form of ordinary glasses. The mounting unit can be applied to not only these spectacle-type apparatuses but also a helmet-type or a hat-type apparatus. Also, the mounting unit does not need to be worn on the head, but it is sufficient if the mounting unit can be worn on some part of the user's body.

The glass lens portion 11a is formed of a transparent (i.e., photo-transmissive) member and covers the portion in front of the user's eyes. The glass lens portion 11a is provided with a windshield portion 11c extending inwardly toward the user's face from an outer peripheral edge, and is intended to protect the eyes. The temple portion 11b is provided on each end portion in the y-axis of the glass lens portion 11a, and each of the temple portions 11b is mounted to be foldable with a hinge 11d.

The image pickup unit 12 comprises a fixed portion 2 which is fixed to the mounting unit 11, and a movable portion 4 which is coupled to the fixed portion 2 movably by a coupling mechanism 3. The fixed portion 2 is structured such that a control substrate (not shown), etc., for controlling the image pickup unit 12 is accommodated in a housing 21. The housing 21 is formed of, for example, resin or metal, and is secured to the temple portion 11b. The way of securing the housing 21 can be adopted arbitrarily. For example, the temple portion 11b can be fitted into a groove formed on the housing 21. Other than the above, the housing 21 may be secured to the temple portion 11b by means of a screw or bonding. It should be noted that what is required for the fixed portion 2 is that it has a fixed (stationary) state relative to the movable portion 4, and the housing 21 can be removably mounted on the temple portion 11b by a clip, a band, or a hook, for example. Alternatively, the housing 21 may be secured to the glass lens portion 11a or the windshield portion 11c, instead of the temple portion 11b.

The control substrate accommodated in the housing 21 is connected to a main control unit (not shown) which is provided separately from the image pickup unit 12 via a cable 13. The control substrate and the main control unit may be wirelessly connected. The main control unit is mounted on, for example, the user's waist, supplies power to an image pickup element portion 41b of a camera module 41, an emission portion 42a of a laser beam irradiation module 42, etc., which will be described later, via the cable 13 and the control substrate, etc., and controls the operation of the image pickup element portion 41b and the emission portion 42a. Switches (not shown) for switching the image pickup element portion 41b and the emission portion 42a on and off, for example, are exposed from the housing 21, the pickup element portion 41b and the emission portion 42a may be operated by each of these switches. The form of the switches is not particularly limited, and each switch may be a button switch, a slide switch, and the like.

In addition to FIGS. 1 and 2, FIGS. 3 to 5 show the structure of the movable portion 4. The movable portion 4 comprises the camera module 41, and the laser beam irradiation module 42. The camera module 41 and the laser beam irradiation module 42 are accommodated in a housing 43. The housing 43 is formed of, for example, resin or metal, and is movably attached to the housing 21 of the fixed portion 2 by the coupling mechanism 3. In this way, the position of the movable portion 4 relative to the fixed portion 2 can be changed by the coupling mechanism 3.

The camera module 41 is formed by comprising the lens portion 41a and the image pickup element portion 41b. The lens portion 41a is configured to have a lens provided within a lens tube, and arranged in the housing 43 such that the lens within the lens tube faces the outside from an opening 43a of the housing 43. The opening 43a is a condensing opening of the lens. The image pickup element portion 41b is connected to the main control unit via a cable 14, the control substrate within the housing 21, and the cable 13, and converts light gathered by the lens portion 41a into electrical signals. The image pickup element portion 41b can be structured by applying elements such as a complementary metal oxide semiconductor (CMOS) or a charge coupled device (CCD).

The housing 43 of the movable portion 4 is mounted on the housing 21 of the fixed portion 2 such that the lens portion 41a of the camera module 41 is directed in the line of sight of the user. Consequently, the camera module 41 can catch the range including the user's view as a subject by the lens portion 41a, and capture that image by the image pickup element portion 41b. That is, the range including the user's view falls within the angle of view of the camera module 41.

The laser beam irradiation module 42 is formed by comprising the emission portion 42a, which is the source of emitting the laser beams, and a control unit 42b which controls the emission portion 42a. The emission portion 42a faces the outside from an opening 43b of the housing 43, and emits a red, blue, green, or the like, laser beam. That is, the opening 43b is an irradiation hole of a laser beam, and laser beams are irradiated toward the outside from the opening 43b and illuminate the subject by pointing to it. The control unit 42b is accommodated within the housing 43 of the movable portion 4, and is fed with power from the main control unit (not shown) mounted on the user's waist, etc., via the cables 13 and 14. Note that the control unit 42b may be accommodated within the housing 21 of the fixed portion 2. Also, the laser beam irradiation module 42 may comprise a power source for the control unit 42b.

Each of the camera module 41 and the laser beam irradiation module 42 is arranged in the housing 43 such that the laser beam from the emission portion 42a is irradiated within the angle of view of the lens portion 41a. That is, the irradiation destination of the laser beam falls within the range of the angle of view of the lens portion 41a. Accordingly, by irradiating the laser beam from the laser beam irradiation module 42 (the emission portion 42a), the user can easily visually recognize an approximate range imaged by the camera module 41 (the image pickup element portion 41b) from the position of the irradiated laser beam.

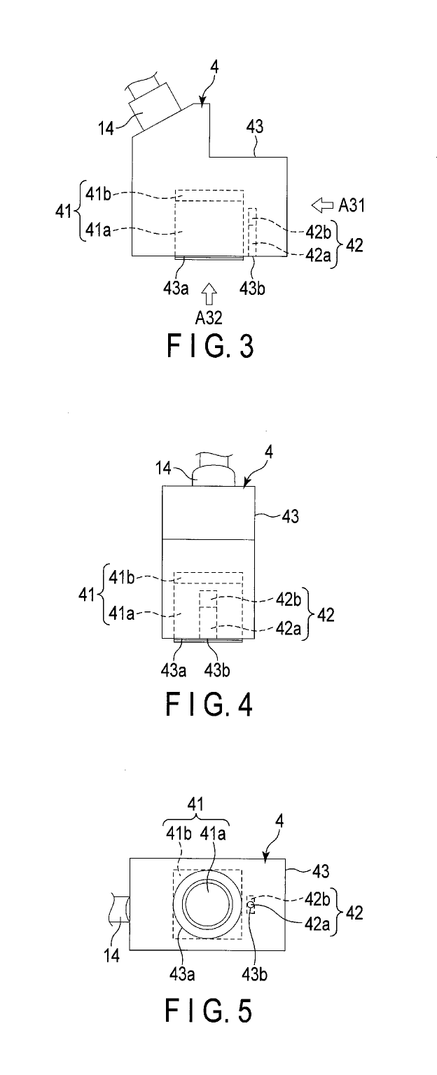

FIGS. 3 to 5 show the way in which the camera module 41 and the laser beam irradiation module 42 are arranged within the housing 43 side by side, and the openings 43a and 43b are also arranged side by side, as an example. The openings 43a and 43b are formed adjacent to each other. The housing 43 is mounted on the housing 21 such that the opening 43b is positioned slightly more inwardly than the opening 43a (to the right side in FIG. 3).

As shown in FIGS. 1 and 2, each of the camera module 41 and the laser beam irradiation module 42 is arranged in the housing 43 such that optical-axis direction D1 and laser-beam-irradiation direction D2 become parallel. In this case, the camera module 41 is arranged to bring the condensing direction of the lens portion 41a and the normal direction of a condensing surface of the image pickup element portion 41b into agreement with optical-axis direction D1. Accordingly, laser-beam-irradiation direction D2 substantially agrees with the imaging direction of the camera module 41. That is, the irradiation destination of the laser beam corresponds to a point near the center of the angle of view of the camera module 41. In this way, the user can correctly visually recognize the imaging range of the camera module 41.

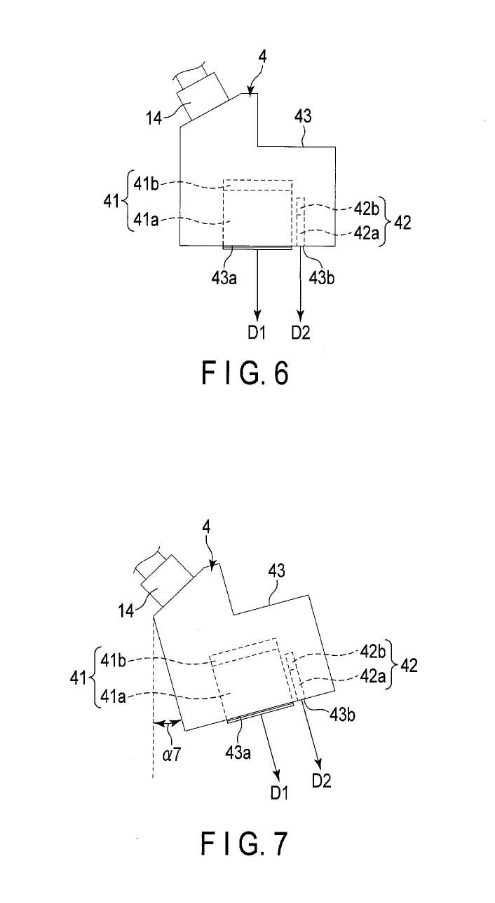

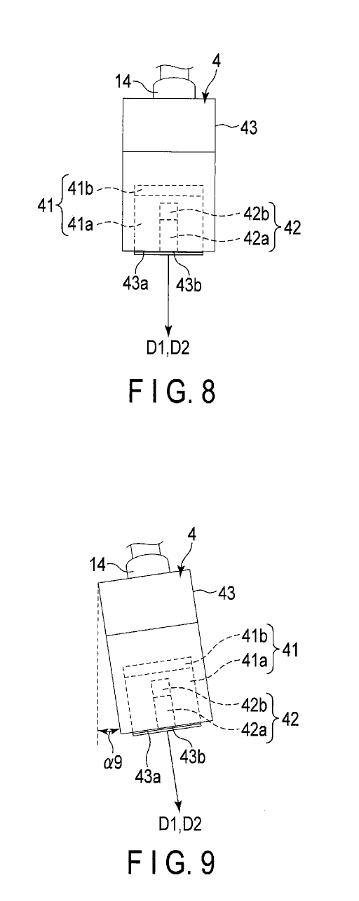

In the present embodiment, since the movable portion 4 is freely movable relative to the fixed portion 2, the user can easily adjust the position of the movable portion 4 with respect to the fixed portion 2, that is, the imaging range of the camera module 41, in order to obtain the optimum angle of view. FIGS. 6 to 9 show the way in which the movable portion 4 can move. FIGS. 6 and 7 are illustrations showing the way in which the movable portion 4 is moved on an x-y plane as seen from the positive z-axis. FIGS. 8 and 9 are illustrations showing the way in which the movable portion 4 is moved on an x-z plane as seen from the positive y-axis.

In a mode shown in FIG. 6, the movable portion 4 is located on the fixed portion 2 (not shown) such that optical-axis direction D1 of the camera module 41 and irradiation direction D2 of a laser beam from the laser beam irradiation module 42 both conform to the reference direction (the direction pointed downward in FIG. 6). When the movable portion 4 is pressed inwardly (i.e., to the right in FIG. 6) from this position, the position of the movable portion 4 is changed to that indicated in FIG. 7 by the coupling mechanism 3 (not shown).

In this case, optical-axis direction D1 of the camera module 41 and irradiation direction D2 of a laser beam from the laser beam irradiation module 42 are more inwardly oriented by angle α7 on the x-y plane than in the mode shown in FIG. 6. By moving (inclining) the movable portion 4 in such a way, the imaging range of the camera module 41, that is, the angle of view, can be corrected to be in the inner side on the x-y plane. When this is performed, the user can easily ascertain that the angle of view has been corrected from a change in laser-beam-irradiation direction D2, in other words, the change in the position of the point where the laser beam irradiates the subject. When the angle of view of the camera module 41 is to be corrected to come at the outer side on the x-y plane, the movable portion 4 may be inclined outwardly (i.e., to the left in FIG. 6) from the position shown in FIG. 6.

In a mode shown in FIG. 8, the movable portion 4 is located on the fixed portion 2 such that optical-axis direction D1 of the camera module 41 and irradiation direction D2 of a laser beam from the laser beam irradiation module 42 both conform to the reference direction (the direction pointed downward in FIG. 8). When the movable portion 4 is pressed downward (i.e., to the right in FIG. 8) from this position, the position of the movable portion 4 is changed to that indicated in FIG. 9 by the coupling mechanism 3.

In this case, optical-axis direction D1 of the camera module 41 and irradiation direction D2 of a laser beam from the laser beam irradiation module 42 are more downwardly oriented by angle α9 on the x-z plane (i.e., to the right in FIG. 8) than in the mode shown in FIG. 8. By moving (inclining) the movable portion 4 in such a way, the imaging range of the camera module 41, that is, the angle of view, can be corrected to be in the lower side on the x-z plane. When this is performed, the user can easily ascertain that the angle of view has been corrected from a change in laser-beam-irradiation direction D2 (a change in the position of the point where the laser beam irradiates the subject). When the angle of view of the camera module 41 is to be corrected to come at the upper side on the x-z plane, the movable portion 4 may be inclined upwardly (i.e., to the left in FIG. 8) from the position shown in FIG. 8.

Further, the movable range of the movable portion 4 relative to the fixed portion 2 is not particularly limited. For example, the movable range may be set such that the laser beam is irradiated from the laser beam irradiation module 42 within the range of the user's viewing angle. As an example, with respect to the reference direction shown in FIGS. 6 and 8, it is sufficient if the movable range of approximately 30° to the inner side and the outer side on the x-y plane, and approximately 20° to the upper side and the lower side on the x-z plane can be secured. Further, although not particularly illustrated, the angle of view of the camera module 41 can be corrected on a y-z plane. Also in this case, the user can easily ascertain that the angle of view has been corrected from a change in the position irradiated by the laser beam.

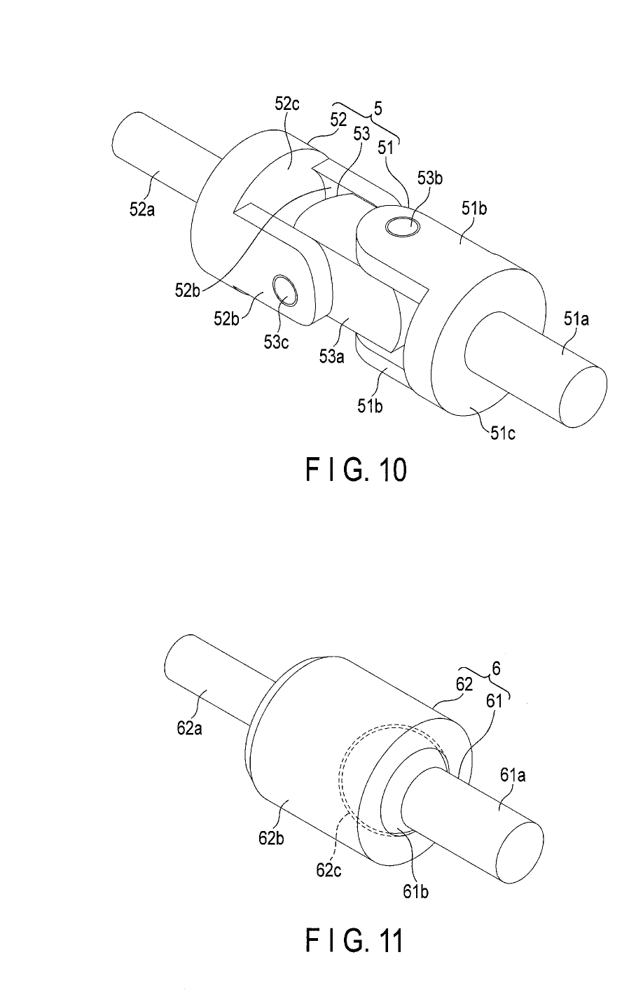

Here, various mechanisms called a universal joint, a ball joint, etc., can be applied to the coupling mechanism 3 for moving the movable portion 4 relative to the fixed portion 2. FIGS. 10 and 11 each show an example of a universal joint 5 and a ball joint 6 which can be applied to the coupling mechanism 3.

The universal joint 5 shown in FIG. 10 is formed by comprising a first coupling member 51, a second coupling member 52, and a support member 53 supporting these coupling members. The first coupling member 51 is provided on the movable portion 4. The first coupling member 51 comprises a shaft part 51a secured to the housing 43, and connection pieces 51b connected to the support member 53. The connection pieces 51b form a pair and protrude from a base 51c provided on an end portion of the shaft part 51a. The second coupling member 52 is provided on the fixed portion 2. The second coupling member 52 comprises a shaft part 52a secured to the housing 21, and connection pieces 52b connected to the support member 53. The connection pieces 52b form a pair and protrude from a base 52c provided on an end portion of the shaft part 52a.

The support member 53 is formed by comprising a main body portion 53a, a first shaft part 53b, and a second shaft part 53c. The main body portion 53a is connected to the connection pieces 51b at one end, and connected to the connection pieces 52b at the other end. The first shaft part 53b penetrates through one end portion of the main body portion 53a, so that the main body portion 53a is connected between the pair of connection pieces 51b to support the first coupling member 51. The second shaft part 53c penetrates through the other end portion of the main body portion 53a, so that the main body portion 53a is connected between the pair of connection pieces 52b to support the second coupling member 52. The first shaft part 53b and the second shaft part 53c are arranged orthogonally relative to each other. That is, the first coupling member 51 and the second coupling member 52 are coupled by the support member 53 with the phases of the pairs of connection pieces 51b and 52b shifted by 90°, respectively.

According to such a universal joint 5, the first coupling member 51 and the second coupling member 52 can be supported by the support member 53 such that they can be mutually rotatable. Accordingly, by fixing the second coupling member 52, the first coupling member 51 can be made to freely rotate relative to the second coupling member 52. That is, the movable portion 4 provided with the first coupling member 51 can be movably coupled to the fixed portion 2 provided with the second coupling member 52.

The ball joint 6 shown in FIG. 11 is formed by comprising a coupling member 61 and a coupled member 62. The coupling member 61 is provided on the movable portion 4. The coupling member 61 comprises a shaft part 61a secured to the housing 43, and a spherical portion 61b provided on an end portion of the shaft part 61a. The coupled member 62 is provided on the fixed portion 2. The coupled member 62 comprises a shaft part 62a secured to the housing 21, and an accommodation portion 62b which rotatably accommodates the spherical portion 61b. The accommodation portion 62b is provided on an end portion of the shaft part 62a, and has a spherical socket 62c which is slightly larger than the spherical portion 61b. The coupling member 61 and the coupled member 62 are connected by accommodating the spherical portion 61b in the socket 62c of the accommodation portion 62b.

According to such a ball joint 6, the coupling member 61 can be made to freely rotate relative to the coupled member 62. That is, the movable portion 4 provided with the coupling member 61 can be movably coupled to the fixed portion 2 provided with the coupled member 62. Conversely, even if the coupling member 61 is provided on the fixed portion 2, and the coupled member 62 is provided on the movable portion 4, respectively, the movable portion 4 can be movably coupled to the fixed portion 2, similarly.

Note that when a movable range of the movable portion 4 relative to the fixed portion 2 is not so required, a hinge, for example, which moves (inclines) the movable portion 4 to only the inner side and the outer side on the x-y plane or x-z plane, can be applied to the coupling mechanism 3.

In this manner, according to the above-described embodiment, the user can correct the camera module 41 simply by hand to have the optimum angle of view. Accordingly, it is possible to easily bring the user's view and the angle of view of the image pickup apparatus 1 into agreement. Consequently, even if a single image pickup apparatus 1 is used by several people in turn, for example, the optimum image can be captured in accordance with each user's view at all times.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wearable image pickup apparatus comprising:
a mounting unit configured to be mounted on a user; and
an image pickup unit on the mounting unit, wherein
the image pickup unit comprises a fixed portion fixed to the mounting unit, and a movable portion movably coupled to the fixed portion by a coupling mechanism,
the movable portion comprises a camera module configured to capture an image of a subject, and a laser beam irradiation module configured to irradiate a laser beam, and
the camera module and the laser beam irradiation module are configured to irradiate the laser beam from the laser beam irradiation module within a range of an angle of view of the camera module.

2. The wearable image pickup apparatus of claim 1, wherein the camera module and the laser beam irradiation module are configured so that an optical-axis direction of the camera module and a direction of irradiating the laser beam from the laser beam irradiation module are parallel to each other.

3. The wearable image pickup apparatus of claim 1 or 2, wherein a movable range of the movable portion relative to the fixed portion achieved by the coupling mechanism is set to irradiate the laser beam within a range of a viewing angle of the user.

4. The wearable image pickup apparatus of claim 1, wherein in the movable portion, a condensing opening of the camera module and a laser-beam irradiation hole of the of the laser beam irradiation module are formed adjacent to each other.

5. The wearable image pickup apparatus of claim 1, wherein:
the coupling mechanism comprises a first coupling member on the fixed portion, a second coupling member on the movable portion, and a support member rotatably supporting the first coupling member and the second coupling member to each other, and
the support member comprises a first shaft part supporting the first coupling member, and a second shaft part which is arranged in a direction orthogonal to the first shaft part and supporting the second coupling member.

6. The wearable image pickup apparatus of claim 1, wherein:
the coupling mechanism comprises a coupling member on one of the fixed portion and the movable portion, and a coupled member on the other one of the fixed portion and the movable portion, and
the coupling member and the coupled member are configured so that the coupling member is rotatable relative to the coupled member.

7. The wearable image pickup apparatus of claim 1, wherein the coupling mechanism is a universal joint or a ball joint.

8. The wearable image pickup apparatus of claim 2, wherein:
the camera module comprises a lens portion, and an image pickup element portion configured to convert light gathered by the lens portion into an electrical signal, and
the lens portion and the image pickup element portion are configured so that each of a condensing direction of the lens portion and a normal direction of a condensing surface of the image pickup element portion conforms to the optical-axis direction.

9. The wearable image pickup apparatus of claim 1, wherein the laser beam irradiation module comprises an emission portion configured to illuminate the subject by a point of the laser beam.

10. The wearable image pickup apparatus of claim 1, wherein the mounting unit comprises a glass lens portion which covers a portion in front of the user's eyes, and a temple portion configured to be foldably supported on the glass lens portion.
